(19) United States
(12) Patent Application Publication
(10) Pub. No.: US 2020/0050906 A1
(43) Pub. Date: Feb. 13, 2020

(54) DYNAMIC CONTEXTUAL DATA CAPTURE

(71) Applicant: SAP SE, Walldorf (DE)

(72) Inventor: Jackson Mathai, Frankfurt (DE)

(21) Appl. No.: 16/056,635

(22) Filed: Aug. 7, 2018

(51) Int. Cl. G06K 9/72; G06F 17/30; G06K 7/14; G06F 3/0482; G06K 9/32; G06K 9/00

(52) U.S. Cl. CPC G06K 9/726; G06F 17/30879; G06K 7/1413; G06K 2209/01; G06K 9/3258; G06K 9/00671; G06F 3/0482

(57) ABSTRACT

Disclosed herein are system, method, and computer program product embodiments for scanning and identifying a physical object. An individual may send the scanned object to a recognition engine. The recognition engine may determine the nature of the physical object using an object recognition model and a semantic meaning for any written text on the physical object using a natural language processing model. User-entered context may be displayed for and received from users related to the identified physical object. An appropriate set of actions to perform in response to the scan may be determined and subsequently performed on the mobile device.

### BACKGROUND

User interaction with mobile devices may involve the manual entry of text. Users may view text written on physical objects and manually enter the text into the mobile device. For users, this manner of interaction may be time consuming, frustrating, and error prone.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the art(s) to make and use the embodiments.

FIG. 1 illustrates an example data capturing facility, according to some embodiments.

FIGS. 2A-2G are example screen displays of a data capturing mobile device, according to some embodiments.

FIGS. 3A-3D are example screen displays of a data capturing mobile device receiving user feedback, according to sonic embodiments.

FIG. 4 is a flowchart illustrating a method of identifying a scanned object with a data capturing mobile device and providing appropriate options to die data capturing mobile device, according to some embodiments.

FIG. 5 is a flowchart illustrating a method of receiving contextual information in a data capturing facility, according to some embodiments.

FIG. 6 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for identifying a scanned object and providing options relevant to the object to a data capturing mobile device.

User interaction with mobile devices may involve the manual entry of text. Despite improvements in keyboard technologies, voice recognition software, and other human-computer interaction advancements, entering text may be time consuming, frustrating, and error prone. Moreover, users may see written text on a physical object and then have to manually enter identical data into the mobile device via a keyboard, keypad, or touchscreen, In addition to written text, users may also enter text describing the actual physical object itself. A user may benefit from technology that obviates the need to duplicate the text and optimizes human-device interactions.

To provide several examples, a user may manually type an email address written on a paper document into a mobile device with the intention of sending an email to the email address. A user may see a billboard that includes a phone number and then type the phone number into a mobile device in order to place a call. A user may identify a location on a physical map, determine an address for the location, and then enter the address into a mobile device in order to navigate to the location. A user may view an object devoid of text, for example, a car, with the intention of performing a web-based search about the make and model of the car on a mobile device.

One will appreciate the expansive nearly limitless variety of physical objects existing in the real-world that a user may scan or photograph. Physical objects may be two-dimensional or three-dimensional. While some scanned physical objects may include written text, other physical objects may not include written text. Text may be written in any suitable natural language or alphanumeric representation, e.g., English, Spanish, Chinese, decimals, binary, etc. Exemplary two-dimensional objects include: pieces of paper, billboards, monitors, screens, or televisions, etc. Exemplary three-dimensional objects may be road signs, trucks, buildings, animals, people, etc. In an alternate embodiment, physical objects may be digital files, e.g., image files, movies, databases, spreadsheets, etc. In one embodiment, the physical object may be a screenshot of an enterprise resource planning or customer relationship management software tool. In one embodiment, a user may select whether to process text on the physical object or focus upon the physical object itself.

A data capturing facility may analyze the setting or situation in a scan in order to recognize a physical object and/or identify any text affixed thereto. Generally speaking, setting analysis may provide a means of applying additional meaning to a captured physical object based on situational cues. Such cues may include: others objects, background information, ambience, colors, conditions, connections or relationships between objects, and any other suitable cues. For example, a data capturing facility may identify a piece of paper as the captured physical object based on the prevalence of white or off-white color in the scan, in another example, a data capturing facility may determine that a scanned object is a coffee mug based on prior artificial intelligence training, in consultation with a library of other images of coffee mugs.

After scanning and identifying the physical object, the mobile device and/or recognition engine may offer a set of actions or options relevant to the captured physical object. In the above example of an email address scanned on a paper document, available options may include sending an email to the email address or adding the email address to an address book in the mobile device, in the above example of a user that scans a car, the options may be related to purchasing cars, renting cars, identifying the make and model of the car, and or performing a web-based searches about cars.

The data capturing facility may improve the performance of setting analysis, natural language processing, and option provision over time by training artificial intelligence models to learn from subsequent user behaviors and user feedback. For example, if users continually select a particular option when capturing a certain physical object (or group of physical objects possessing a certain characteristic), the data capturing facility may update the artificial intelligence models to always or more frequently offer this option, in one embodiment, a user may control opt-in or opt-out of the artificial intelligence training, with only scans from users that opted-in being used to train the artificial intelligence models. In an alternate embodiment, the opt-in/opt-out variable may be stored as a local setting or configuration.

In an embodiment, a data capturing facility may provide additional contextual information about the physical object to users after identifying the physical object. Such contextual information may be internet sources or other external references, e.g., books, encyclopedias, or audio materials. In an embodiment, a data capturing facility may receive contextual information from users. In this embodiment, a user may add information related to an identified physical object and flag the contextual information as public or private.

For public context, any user that subsequently scans a similarly identified physical object may view the user-added public context information. For instance, a user may add an Internet link, contact information, descriptions, or any other suitable additional information to be associated with the physical object. In such an embodiment, a data capturing facility may employ a permission system in order to identify users that have permission to add information related to particular physical objects. For example, a user may have editing permission across all identified physical objects. In another example, users may be assigned editing capabilities for only one physical object or across a subset of physical objects. In an embodiment, the data capturing facility may allow administrators or system operators to approve any added public context.

For private context, the information associated with the physical object may only be available to the user that scanned the physical object and added the private context. A user adding private contextual information may add information about the scanned physical object relevant only to the user. Such private context may not be viewable by other users that scan a similar physical object. For example, a user could add a personal note regarding the scanned physical object, set an appointment or reminder, or provide additional useful information for later viewing.

In an alternate embodiment, a physical object may be images of software applications captured from a screen or monitor or contained in a digital file. These software applications may be a wide-array of web-based or otherwise-deployed applications spanning multitudinous services and industries. For example, and without limitation, software applications may include customer relationship management and enterprise resource planning tools, word processing applications, communication applications, product lifecycle management tools, supply chain management, general business solutions, and many other suitable applications. The software applications may display, retrieve, and otherwise interact with various forms of data. The data may be arranged into tables, charts, graphs, etc. or displayed as raw data. These applications may retrieve the data from a database management system using queries or other retrieval techniques. In this embodiment, a data capturing facility may be able to analyze data scanned or captured in the software applications and provide options related to that specific application and/or data. For example, scanned data may be rearranged or further information retrieved from the software application using a suitable application programming interface. In one embodiment, a scan may result in the captured table data being organized into a more easily readable or manipulable format.

Accordingly, a need exists to identify a physical object and provide appropriate options on a data capturing mobile device while training artificial intelligence models and receiving context information from users.

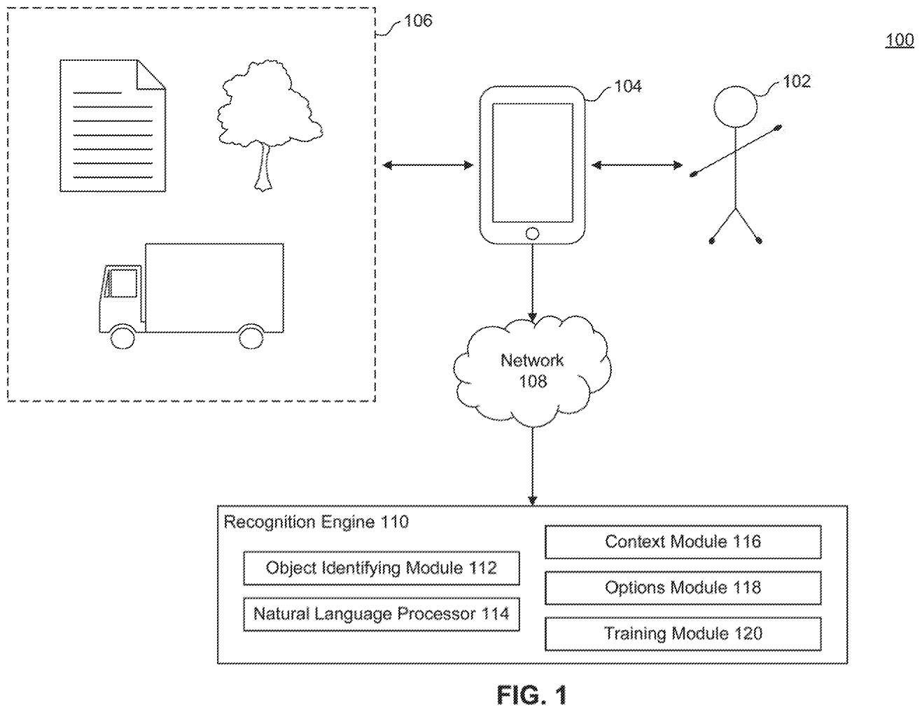

FIG. 1 illustrates an example data capturing facility 100, according to some embodiments. Data capturing facility 100 may include user 102, mobile device 104, physical object 106, network 108, and recognition engine 110.

User 102 may be an individual using a mobile device to scan physical objects. User 102 may employ, i.e., connect to, a network or combination of networks including the Internet, a local area network (LAN), a wide area network (WAN), a wireless network, a cellular network, or various other types of networks as would be appreciated by a person of ordinary skill in the art. In an embodiment, user 102 may be a person, individual, or business using a suite of software applications displaying data arranged into tables, charts, graphs, or displayed in other suitable form. In this embodiment, user 102 may scan the information contained in the suite of software applications.

Mobile device 104 may be personal digital assistant (PDA), desktop workstation, laptop or notebook computer, netbook, tablet, smart phone, smart watch or other wearable, appliance, part of the Internet-of-Things and/or embedded system, to name a few non-limiting examples, or any combination thereof. Mobile device 104 may scan or capture physical objects. Mobile device 104 may include any suitable method of scanning a real-world object including: scanner, camera, microphone, Radio-Frequency Identification (RFID), Near-Field Communication (NFC), etc. In an embodiment, mobile device 104 may run a scanning application locally. Mobile device 104 may further include additional software applications and functionality that provide ancillary actions/options to perform following the scanning of a physical object.

Physical object 106 may be a real-world item, article, body, person, animal, or other object. Physical object 106 may include text or may be devoid of text. Physical object 106 may include any number of different artifacts such as for example any combination of one or more of text (e.g., a name, a street address, telephone number, etc.), geographic coordinates (e.g., latitude and longitude), a geotag, a Quick Response (QR) code, a SnapTag, a Universal Product Code (UPC), a barcode, an image (e.g.,, a logo, a picture, etc.), a human face or an element of same, a sound, a video, etc. These elements may reside, exist, appear, etc. on or within any number of contexts such as for example any combination of one or more of printed (e.g., on paper), a computer display, a smartphone display, a TV screen, a billboard, an advertisement, a display sign (e.g., in a retail establishment), on a vehicle, on a building, etc. Physical object 106 may be captured, read, received, etc. through any of the above-described mechanisms by mobile device 104. Physical object 106 may be a destination, target, location for captured and/or processed data, information, etc. and may optionally be specified or indicated by any combination user or a system components. In an embodiment, a location may be a portion, element, screen, etc. of a software application. Physical object 106 may further include: addresses, names, telephone numbers, fax numbers, email addresses, web links, folder paths, vehicle number plates, ERP data, connected databases, barcodes, or any other suitable information.

Network 108 may be any network or combination of networks including the Internet, a local area network (LAN), a wide area network (WAN), a wireless network, a cellular network, or various other types of networks as would be appreciated by a person of ordinary skill in the art.

Recognition engine 110 may include object identifying module 112, natural language processor 114, context module 116, options module 118, and training module 120. Recognition engine 110 may receive transmissions from mobile device 104 and send transmissions to mobile device 104 via network 108.

Object identifying module 112 may recognize and identify physical object 106 as captured by mobile device 104. Object identifying module 112 may determine that portions of physical object 106 contain text. Object identifying module 112 may also, determine the object on which the text is affixed, for instance, on a piece of paper or on the side of a truck. Object identifying module 112 may analyze the setting and other situational information about physical object 106 to draw further conclusions about the nature of physical object 106. Object identifying module 112 may consider the colors, shapes, faces, or other background information captured in the scan. In an embodiment, object identifying module 112 may consider the time of day or other circumstantial information. In an embodiment, where physical object 106 captures information from a software application, object identifying module 112 may consider the software applications that user 102 generally works with, permissions within those software applications, and other related information. In an embodiment, object identifying module 112 may consider actions that user 102 completed previously.

Natural language processor 114 may leverage or employ elements of Machine Learning (ML), Artificial Intelligence (AI), Natural Language Processing (NLP), etc. to determine the semantic meaning of text on scanned physical objects, such as physical object 106. Natural language processor 114 may provide a manner of analyzing and understanding human language by an automated system. Natural language processor 114 may use machine learning and language analysis to ascertain a semantic, meaning behind scanned text. Natural language processor 114 may analyze the natural language to determine a semantic meaning using semantic parsing, latent semantic indexing/analysis, command and control approaches, semantic tagging, word distance functions, vector space models, or other natural language processing toolkits/methodologies. Natural language processor 114 may harness a model, i.e., supervised machine learning, to further support text extraction and analysis. Natural language processor 114 may use a dictionary associated with the model to derive further meaning from scanned natural language. Natural language processor 114 may invoke formal rule definitions, statistical language modeling, connectionist language modeling, vector space modeling, neural language modeling, or other manners of analyzing human language. Natural language processor 114 may employ language- or culture-structures to analyze natural language among and across different populations.

Context module 116 may receive additional contextual information about identified physical object 106 and provide the contextual information to users when a similar physical object 104 is scanned and identified in the future. Context module 116 may receive context that is public or private. Context module 116 may provide public context information to any user that subsequently scans a similar physical object. Context module 116 may provide private context information only to the user that added the private context information. Context module 116 may employ appropriate permission systems in order to determine which users may add public context habituation. In one embodiment, context module may require that a system administrator approve any added public context.

Options module 118 may determine an option or set of options available to perform based on the nature of physical object 106 as determined by object identifying module 112. Options module 118 may consider the semantic meaning of text included in the scan as determined b natural language processor 114. Options model may consider the setting or situation. Options module 118 may consider contextual information stored by context module 116. Options module 118 may leverage software applications embedded in or contained on mobile device 104, or options module 118 may consider functionality contained in recognition engine 110. Options module 118 may present available actions as a list of texts, a list of icons, a list of links, or other suitable construct. Options module 118 may provide multiple options for a user to select from, or options module 118 may present only one option to perform or perform an action automatically.

Training module 120 may update or train artificial intelligence constructs as recognition engine 110 receives further scans. Training module 120 may receive a satisfaction indicator or other cue from user 102 in order to update models in natural language processor 114, context module 116, and options module 118. In an embodiment, training module 120 may receive a satisfaction indicator from user 102 to train artificial intelligence constructs. In an embodiment, the satisfaction indicator may be implied by subsequent user behavior, for example, if user 102 immediately conducts another scan or selects local functionality not suggested as an option by options module 118.

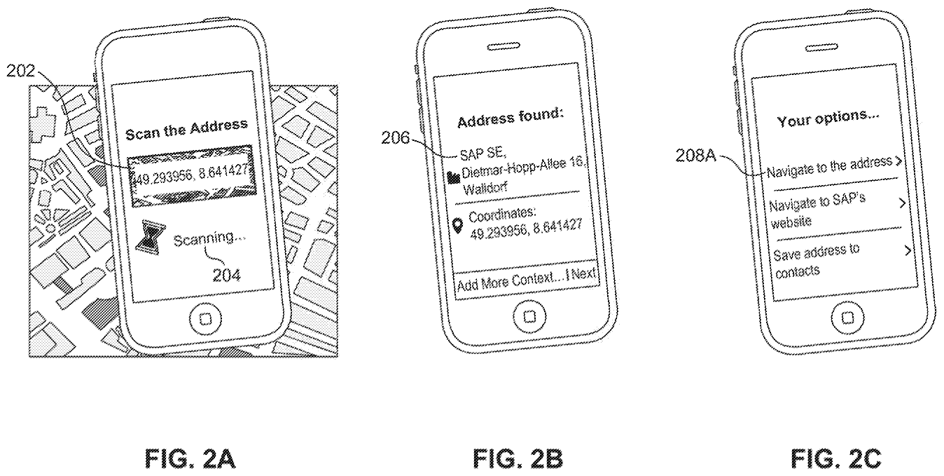

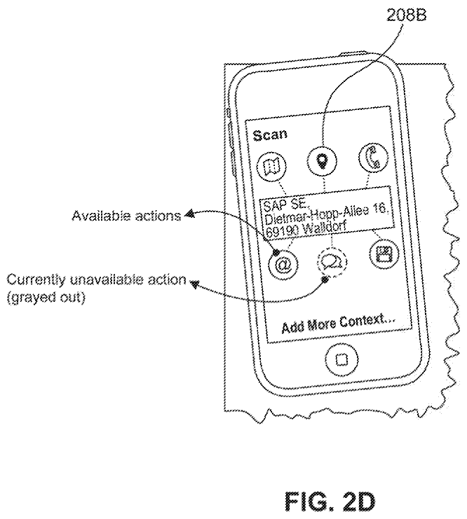

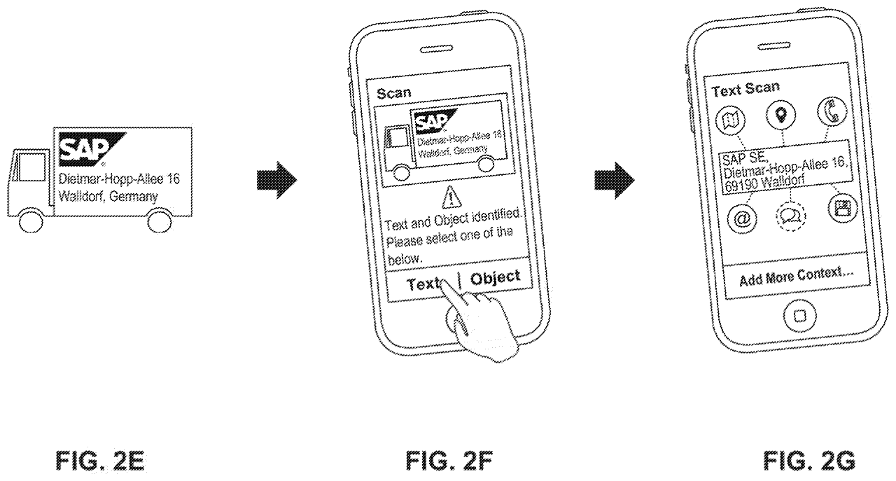

FIGS. 2A-2G are examples of screen display 200, as rendered on a data capturing mobile device, such as mobile device 104, according to some embodiments. Screen display 200 may include scan window 202, message 204, result 206, and options 208. The screen displays provided in FIGS. 2A-2G are merely exemplary. One skilled in the relevant art(s) will appreciate that many approaches may be taken to provide a suitable screen display 200 in accordance with this disclosure.

Scan window 202 may focus on or center upon a real-world object, such as physical object 106, to facilitate the scanning, capturing, photographing, etc. of physical object 106. Scan window 202 may employ a box, circle, target, or other suitable visualization cue to frame physical object 106. Scan window 202 may be resized, refocused, adjusted, or reshaped to allow user 102 to more narrowly focus a scanned area. In an embodiment, scan window 202 may include a primary scan window 202 to highlight physical object 106 and a second scan window 202 to ascertain the setting or gather situational clues. In another embodiment, scan window 202 may include capabilities for automatically focusing upon any natural language or numbers.

Message 204 may provide feedback, communications, or further information from recognition engine 110 to user 102. Message 204 may be written in any suitable language, e.g. message 204 may be written in English. However, message 204 may communicate with the user using any suitable text or interaction technique, for example, with images or other visual cues.

Result 206 may provide a result to user 102 after object identifying module 112 determines physical object 106. Result 206 may provide further information when natural language processor 114 completes semantic analysis. Result 206 may display previously received context information, public or private, relevant to physical object 106.

Options 208 may be options or actions provided to user 102 on mobile device 104 via recognition engine 110. Options 208 may include only one option, or options 208 may include multiple options. Options 208 may include no options if options module 118 cannot determine a suitable action related to the capture. One skilled in the relevant arts will understand that a wide-array of available options exist that may be performed by mobile device 104. In an embodiment, options 208 may vary based on a device-type of mobile device 104. In another embodiment where information from a software application is captured, options 208 may vary according to the nature of and functionality provided within the software application as well as associated permissions in the software application specific to user 102.

Focus selector 210 may be a selector provider to user 102 on mobile device 104 to indicate whether text included on physical object 106 should be focused on by recognition engine 110 as opposed to the physical object itself. Focus selector may be a toggle, select, or other suitable input mechanism allowing user 102 to make the differentiation. In an alternate embodiment, focus selector 210 may determine whether to focus on the text or physical object based on the nature of the captured image in scan window 202.

In the example provided in FIG. 2A, physical object 106 is a map including coordinates amid other geographic and cartographic features. In FIG. 2A, scan window 202 focuses on the coordinates “49.293956, 8.641427,” while also capturing additional situational information from the images, i.e., that the captured coordinates are affixed to a map.

In the example provided in FIG. 2B, recognition engine 110 identifies physical object 106 as coordinates on a map and displays the findings on mobile device 104 for user 102 as result 206. In order to make this determination, mobile device 104 may interact with recognition engine 110 via network 108. Recognition engine 110 may in turn leverage object identifying module 112, natural language processor 114, and context module 116 to determine an appropriate message to display as result 206. In an alternate embodiment, mobile device 104 may determine result 206 locally. In the exemplary embodiment of FIG. 2B, recognition engine 110 locates an address related to these coordinates of “SAP SE, Dietmar-Hopp-Allee 16, Walldorf,” and mobile device 104 displays the address for consideration by user 102.

In the example provided in FIG. 2C, recognition engine 110 identifies options 208 related to the identified address displayed in FIG. 2B. In an embodiment, recognition engine 110 determines the available options via options module 118. In the exemplary embodiment of FIG. 2C, mobile device 104 provides options to “Navigate to the address,” “Navigate to SAP's website,” and “Save address to contacts.” The options presented are in no way exhaustive and are provided herein only for illustrative purposes. Other suitable options 208 may be provided. Options 208 may vary based on physical object 106, the nature of mobile device 104, previously received context information, the artificial intelligence models, the software application scanned (if applicable), situational information (e.g., time-of-day), and a wide-array of other factors.

In the example provided in FIG. 2D, an alternate methodology for displaying options 208 is displayed. In this approach, mobile device 104 displays options 208 as images with unavailable options being grayed out or otherwise not clickable, in the exemplary embodiment of FIG. 2D, options 208 include: adding the address to the address book, marking the location on a map, calling a phone number attributable to the location, posting a tweet, sending a message, or storing the information locally. The options displayed in FIG. 2D are not exhaustive, and the available options and icons representing those options may vary.

In the example provided in FIG. 2E, an alternate physical object 106 is displayed. In this example, physical object 106 is a truck that also includes textual components in the form of a written address.

In the example provided in FIG. 2F, scan window 202 focuses upon the truck that includes text component. In this example, user 102 may expressly select between “Text” and “Object.” Selecting “Text” may result in data capturing facility 100 focusing upon the text written on the side of the truck while selecting “Object” may result in data capturing facility 100 focusing upon the truck itself when identifying the physical object and providing appropriate options.

In the example provided in FIG. 2G, mobile device 104 displays the determined options based on the selection of “Text” and allows a user to add context information about physical object 106 by clicking “Add More Context.”

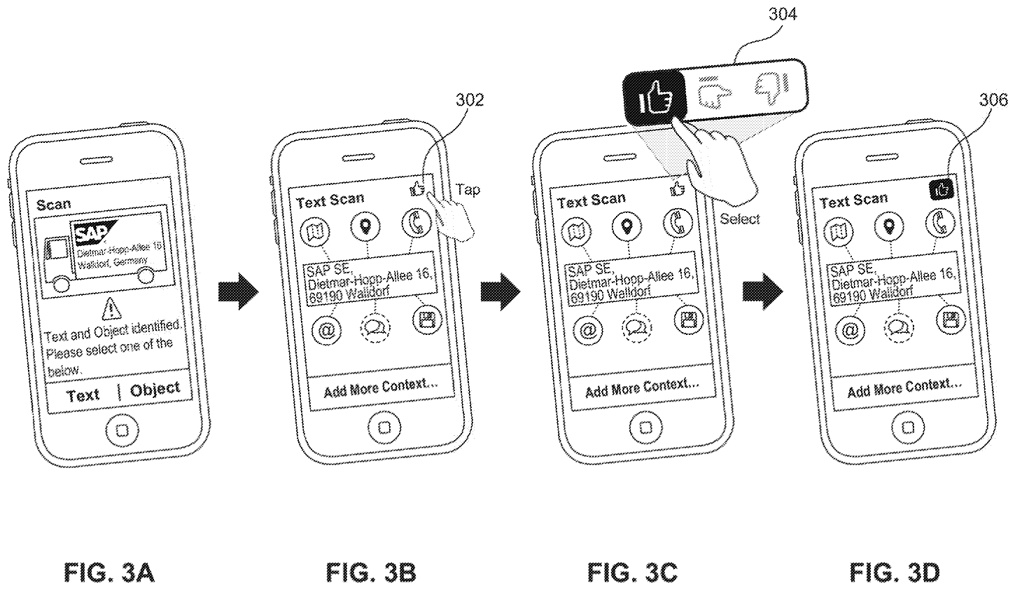

FIGS. 3A-3D are further examples of screen display 200, as rendered on a data capturing mobile device, such as mobile device 104, according to some embodiments.

Feedback icon 302 may be included in screen display 200 on mobile device 104 to allow user 102 to provide additional feedback about the determined physical object 106 and options 208 in order to train recognition engine 110 to return better results in the future. Feedback icon 302 may be any suitable visual cue indicating that input may be received by mobile device 104. Feedback icon 302 may accept numerous forms of input to activate related functionality such as tapping or swiping with a finger, clicking with a mouse, etc.

Satisfaction indicator 304 may provide a user with the ability to indicate their level of satisfaction with the determined physical object 106 and options 208. For example, satisfaction indicator 304 may allow users to enter a quantitative rating such as a thumbs up or thumbs down icon, a star rating (e.g., 1-5 stars), a score from one to ten, or a qualitative indicator such as a narrative field. In an embodiment, training module 120 may train, update, or adjust artificial intelligence models and dictionaries used by object identifying module 112, natural language processor 114, context module 116, and options module 118 based on a received satisfaction indicator 304. For example, if user 102 provides a positive satisfaction indicator, training module 120 may increase the likelihood of object identifying module 112, natural language processor 114, context module 116, and options module 118 making similar determinations in the future when confronted with a similar physical object 106.

Stored feedback 306 may display a previously received and stored satisfaction indicator 304 by user 102. Stored feedback 306 may be displayed immediately after reception from user 102 or be stored for later recall.

In the example provided in FIG. 3A, scan window 202 captures physical object 106, which in this example is a truck with text written on the side. User 102 indicates via focus selector 210 that recognition engine 110 should focus on the text.

In the example provided in FIG. 3B, screen display 200 displays the identified location and provides relevant options 208. In this example, screen display 200 also includes feedback icon 302.

In the example provided in FIG. 3C, user 102 clicks, gestures, activates, or otherwise inputs upon feedback icon 302. In response, screen display 200 displays satisfaction indicator 304. In this example, satisfaction indicator 304 includes three options, a thumbs-up icon, a thumbs-neutral icon, and a thumbs-down icon.

In the example provided in FIG. 3D, screen display 200 displays stored feedback 306 as a thumbs-up icon, indicating that user 102 provided positive feedback to the determine options 208 and physical object 106.

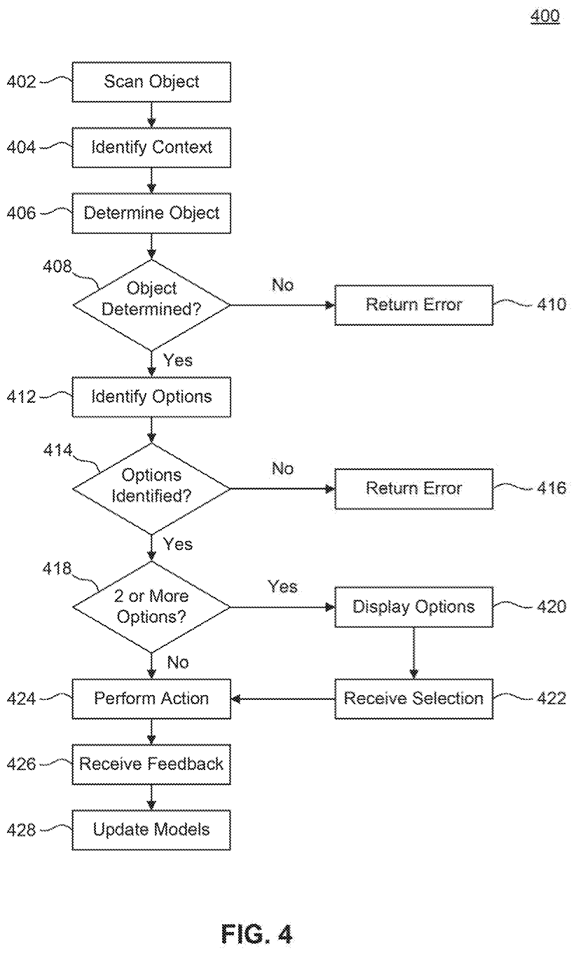

FIG. 4 is a flowchart illustrating a method 400 of identifying a scanned object, such as physical object 106, with a data capturing mobile device, such as mobile device 104, and providing appropriate options, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art(s).

In 402, mobile device 104 may scan, take a picture of, or use other suitable method to scan/capture physical object 106. In an embodiment, mobile device 104 may transmit the scan to recognition engine 110 via network 108. As described above with reference to FIG. 2, user 102 may frame a scan via scan window 202 or use another similar construct to focus on a portion of physical object 106. Physical object 106 may include any number of different artifacts such as for example any combination of one or more of text (e.g., a name, a street address, telephone number, etc.), geographic coordinates (e.g., latitude and longitude), a geotag, a Quick Response (QR) code, a SnapTag, a Universal Product Code (UPC), a barcode, an image (e.g., a logo, a picture, etc.), a human face or an element of same, a sound, a video, etc.

In 404, recognition engine 110 may identify the setting or other situational information from the scan taken in 402 via object identifying module 112. Situational information may include visual information surrounding the scanned area such as colors, shapes, shading, etc. Situational elements may reside, exist, appear, etc. on or within any number of settings such as for example any combination of one or more of printed (e.g., on paper), a computer display, a smartphone display, a TV screen, a billboard, an advertisement, a display sign (e.g., in a retail establishment), on a vehicle, on a building, etc. Object identifying module 112 may employ artificial intelligence techniques to better identify situational information over time.

In 406, recognition engine 110 determines physical object 106 as captured by the scan in 402 via object identifying module 112. In a situation where physical object 106 includes text, natural language processor 114 may capture the text and determine a semantic meaning for the text. Object identifying module 112 and natural language processor 114 may employ artificial intelligence techniques to more effectively determine physical objects captured in future scans. Context module 116 may display previously captured contextual information regarding the identified physical object to user 102.

In 408, method 400 determines whether recognition engine 110 identified physical object 106 in 408. If recognition engine 110 did not successfully identify physical object 106, then method 400 proceeds to 410. If recognition engine 110 successfully identified physical object 106, then method 400 proceeds to 412.

In 410, method 400 ends. Mobile device 104 may provide a suitable error message to user 102. Training module 120 may use the scan and related lack of findings to train artificial intelligence models used by object identifying module 112 and natural language processor 114.

In 412, options module 118 may identify options related to physical object 106 identified in 406. For example, user 102 may be able to send an email, add a contact, place a phone call, rent a car, call a taxi or ride service, perform web searches, copy information to a local cache, send a text message, etc. The options identified may vary based on physical object 106, the nature of mobile device 104, the determined context, the artificial intelligence models, the software application, situational information (e.g., time-of-day), and a wide-array of other factors.

In 414, recognition engine 110 determines if options module 118 determined a non-zero number of options in 408. If options module 118 identified one or more options, then method 400 proceeds to 418. If options module 118 identified no options, then method 400 proceeds to 416.

In 416, method 400 ends. Mobile device 104 may provide a suitable error message to user 102. Training module 120 may use the scenario to train artificial intelligence models used by options module 118. For instance, training module 120 ma examine subsequent actions performed by user 102 and store these as possible candidate options for future interactions.

In 418, recognition engine 110 determines if options module 118 determined two or more options in 412. In the event that options module 118 determined only one option, method 400 proceeds to 424. If options module 118 determined more than one option, method 400 proceeds to 420. In an alternate embodiment, method 400 may proceed to 420 even if options module 118 determined only one option.

In 420, mobile device 104 displays the options determined in 412 to user 102. Mobile device 104 may formulate the display in a variety of fashions including as text or as icons, as displayed in the exemplary screen displays in FIG. 2C and FIG. 2D.

In 422, mobile device 104 receives a selected option from user 102 on mobile device 104. In an embodiment, user 102 may select more than one option to perform sequentially or in parallel.

In 424, mobile device 104 executes the action(s) selected in 422 (or determined in 412, if only one action was determined). One skilled in the arts will appreciate the wide-range of options that may be determined by recognition engine 110 and performed by mobile device 104. Thus, a user may scan a physical object and select an appropriate, relevant option without manually entering text or describing the object.

In 426, recognition engine 110 may receive satisfaction indicator and/or context information from user 102. Training module 120 may use the satisfaction indicator to train object identifying module 112, natural language processor 114, and options module 118. Mobile device 104 may display the request for feedback in any suitable fashion, for instance, a quantitative rating such as a thumbs up or thumbs down icon, a star rating (e.g., 1-5 stars), a score from one to ten, or a qualitative indicator such as a narrative field. Context module 116 may receive any private or public context added by user 102 and associate with physical object 105 or otherwise store the context for later recall and display.

In 428, training module 120 may train, update, or adjust artificial intelligence models and dictionaries used by object identifying module 112, natural language processor 114, context module 116, and options module 118. For example, if user 102 provides a positive satisfaction indicator in 410, training module 120 may increase the likelihood of object identifying module 112, natural language processor 114, context module 116, and options module 118 making similar determinations in the future when confronted with a similar physical object 106 and/or text affixed to physical object 106. Thus, recognition engine 110 may provide more accurate and/or efficient results over time.

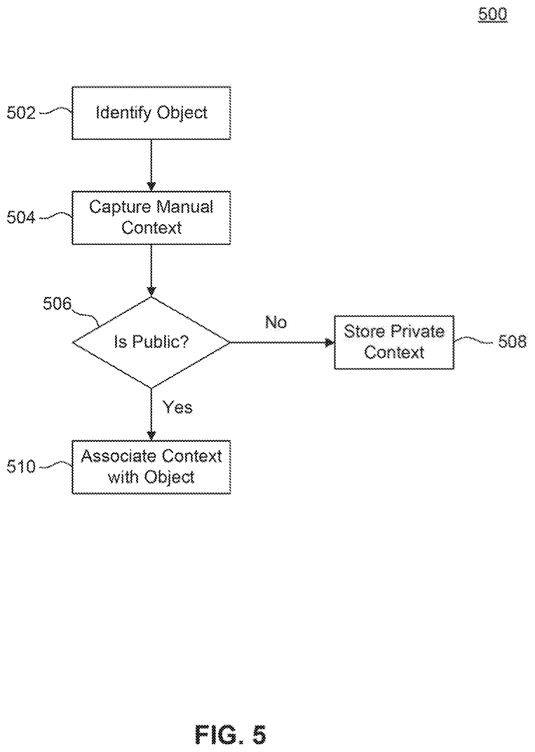

FIG. 5 is a flowchart illustrating a method 500 of receiving contextual information in a data capturing facility, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art(s).

In 502, mobile device 104 may scan, photograph, or use other suitable method to capture physical object 106. As described above with reference to FIG. 2, user 102 may employ scan window 202 or another similar construct to focus on a portion of physical object 106. A scanned area may include text, numerals, of other symbols, contextual information, and other visual cues. In an embodiment, mobile device 104 may transmit the scan to recognition engine 110 via network 108. As described above with reference to FIG. 3, recognition engine 110 determines the nature of physical object 106 based on settings or other situational information and returns an option or a list of options to user 102 for selection.

In 504, context module 116 receives context from user 102 entered manually to be associated with the physical object identified in 502. Manual context may be internet sources or other external references, books, encyclopedias, audio materials, text descriptions and details, and any other suitable information type. User 102 may also identify whether the contextual information is public or private.

In 506, recognition engine 110 determines if the context is public or private. If the context is private, then method 500 proceeds to 508. If method 500 is public, then method 500 proceeds to 510.

In 508, context module 116 associates the private context received in 504 with the identified physical object 106. Context module 116 may also link, catalog, or otherwise associate the information with user 102. Thus, only user 102 may receive the added information in the future upon subsequent captures of a similar physical object 106.

In 510, associates the public context received in 504 with the identified physical object 106. In an embodiment, context module 116 may employ a permission system in order to identify whether user 102 is permitted to add information related to identified physical object 106. In another embodiment, context module 116 may require an administrator to review the added information prior to associating the context with a similar physical object.

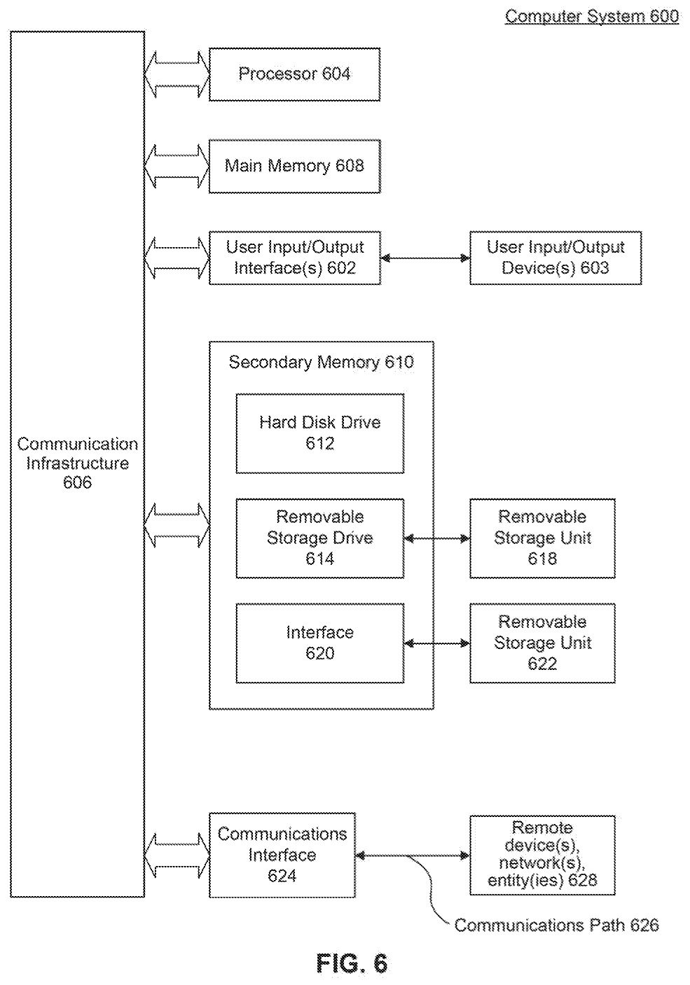

FIG. 6 is an example computer system useful for implementing various embodiments. Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, of CPUs), such as a processor 604. Processor 604 may be connected to a communication infrastructure or bus 606.

Computer system 600 may also include user input/output device(s) 602, such as monitors, keyboards, pointing devices, etc., which may communicate with communication infrastructure or bus 606 through user input/output device(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 608, such as random access memory (RAM). Main memory 608 may include one or more levels of cache. Main memory 608 may have stored therein control logic computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 514 may interact with a removable storage unit 518. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interlace 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the clams. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting, the generality of this paragraph, embodiments are not limited to the software, hardware, firmware, and/or entities illustrated in the figures and or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein fur the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described, using the expression “coupled” and “connected” along with their derivatives. These terms are not necessarily intended as synonyms for each other. For example, some embodiments can be described using the terms “connected” and/or “'coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method, comprising:
scanning a physical object comprising written text in a scan window on a mobile device;
determining, by a recognition engine, a setting applicable to the physical object using an object recognition model;
deriving, by the recognition engine, a semantic meaning for the written text using a natural language processing model that considers the setting;
selecting, by the recognition engine, a set of actions performable on the mobile device based on the semantic meaning and an artificial intelligence model;
causing execution of an action in the set of actions on the mobile device; and
updating the artificial intelligence model based on the action and a satisfaction indicator,
wherein at least one of the scanning, determining, deriving, selecting, causing and updating are performed by one or more computers.

2. The method of claim 1, further comprising:
providing the set of actions to the mobile device;
receiving a selected action from the set of actions; and
executing the selected action on the mobile device.

3. The method of claim 1, further comprising:
determining an application context related to the physical object and the written text, wherein the physical object is a software application and the written text is data in the software application; and
determining the set of actions from actions available in the software application related to the application context.

4. The method of claim 1, further comprising:
identifying a universal product code affixed to the physical object;
determining a product associated with the universal product code; and
retrieving information about the product to display on the mobile device.

5. The method of claim 1, further comprising:
receiving, by the recognition engine, a satisfaction indicator in response to providing the set of actions to the mobile device; and
updating the natural language processing model based on the satisfaction indicator.

6. The method of claim 1, further comprising:
receiving, by the recognition engine, a satisfaction indicator in response to providing the set of actions to the mobile device; and
updating the object recognition model based on the satisfaction indicator.

7. The method of claim 1, further comprising:
receiving context information related to the physical object from the mobile device;
receiving an indication from the mobile device as to whether the context information is public or private; and
when the context information is public, displaying the context information to a second mobile device that scans a similar physical object.

8. The method of claim 1, further comprising:
receiving context information related to the physical object from the mobile device;
receiving an indication from the mobile device as to whether the context information is public or private; and
when the context information is private, displaying the context information for the mobile device that scans a similar physical object.

9. A system operable with a mobile device, the mobile device configured to scan a physical object comprising written text in a scan window, and execute an action in a set of actions, the system comprising:
a memory, and
at least one processor coupled to the memory and configured to:
determine a setting applicable to the physical object using an object recognition model;
derive a semantic meaning for the written text using a natural language processing model that considers the setting;
select the set of actions based on the semantic meaning and an artificial intelligence model; and
cause execution of the action in the set of actions on the mobile device; and
update the artificial intelligence model based on the action and a satisfaction indicator.

10. The system of claim 9, the at least one processor further configured to:
provide the set of actions to the mobile device;
receive a selected action from the set of actions; and
execute the selected action on the mobile device.

11. The system of claim 9, the at least one processor further configured to:
determine an application context related to the physical object and the written text, wherein the physical object is a software application and the written text is data in the software application; and
determine the set of actions from actions available in the software application related to the application context.

12. The system of claim 9, the at least one processor further configured to:
identify a universal product code affixed to the physical object;
determine a product associated with the universal product code; and
retrieve information about the product to display on the mobile device.

13. The system of claim 9, the at least one processor further configured to:
receive a satisfaction indicator in response to providing the set of actions to the mobile device; and
update the natural language processing model based on the satisfaction indicator.

14. The system of claim 9, the at least one processor further configured to:
receive a satisfaction indicator in response to providing the set of actions to the mobile device; and
update the object recognition model based on the satisfaction indicator.

15. The system of claim 9, the at least one processor further configured to:
receive context information related to the physical object from the mobile device;
receive an indication from the mobile device as to whether the context information is public or private; and
when the context information is public, display the context information to a second mobile device that scans a similar physical object.

16. The system of claim 9, the at least one processor further configured to:
receive context information related to the physical object from the mobile device;
receive an indication from the mobile device as to whether the context information is public or private; and
when the context information is private, display the context information for the mobile device that scans a similar physical object.

17. A non-transitory computer-readable device having instructions stored thereon that, when executed by at least one computing device, cause the at least one computing device to perform operations comprising:
scanning a physical object comprising written text in a scan window on a mobile device;
determining, by a recognition engine, a setting applicable to the physical object using an object recognition model;
deriving, by the recognition engine, a semantic meaning for the written text using a natural language processing model that considers the setting;
selecting, by the recognition engine, a set of actions performable on the mobile device based on the semantic meaning and an artificial intelligence model;
causing execution of an action in the set of actions on the mobile device; and
updating the artificial intelligence model based on the action and a satisfaction indicator.

18. The non-transitory computer-readable device of claim 17, the operations further comprising:
providing the set of actions to the mobile device;
receiving a selected action from the set of actions; and
executing the selected action on the mobile device.

19. The non-transitory computer-readable device of claim 17, the operations further comprising:
receiving context information related to the physical object from the mobile device;
receiving an indication from the mobile device as to whether the context information is public or private;
when the context information is public, displaying the context information to a second mobile device that scans a similar physical object.

20. The non-transitory computer-readable device of claim 17, the operations further comprising:
receiving context information related to the physical object from the mobile device;
receiving an indication from the mobile device as to whether the context information is public or private;
when the context information is private, displaying the context information for the mobile device that scans a similar physical object.
